(19) United States
(12) Patent Application Publication
(10) Pub. No.: US 2008/0273334 A1
(43) Pub. Date: Nov. 6, 2008

(54) Electric Lamp/Reflector Unit with a Moulded Reflector

(75) Inventor: Leo Ooms, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,107

(22) PCT Filed: Oct. 20, 2006
(86) PCT No.: PCT/IB06/53872

§ 371 Date: Apr. 22, 2008

(30) Foreign Application Priority Data
Oct. 26, 2005 (EP) 05109986.9

(51) Int. Cl. F21V 7/00

(52) U.S. Cl. 362/296

(57) ABSTRACT

The electric lamp/reflector unit has a molded reflector body (1) comprising a hollow neck-shaped portion (5). An electric lamp (10) having a lamp vessel (1), enclosing a space (12) in which an electric element (13) is arranged, and provided with a first (14) and a second, opposed end portion (15) is fixed at its first end portion (14) within the neck-shaped portion (5). At least one outer current conductor (16, 17) extends from the electric element (13) to the outer surface (23) of the lamp/reflector unit via a punched duct (25) in the reflector portion (2) of the molded reflector body (1). Said duct essentially extends in a direction transverse to the outer surface of the reflector body.

The invention relates to an electric lamp/reflector unit comprising:

a molded reflector body provided with a reflector portion having an optical axis, and with an outer surface, and integrally with said outer surface a hollow neck-shaped portion around the optical axis;

a concave reflecting inner surface located between the neck-shaped portion and a light emission window transversely to the optical axis;

an electric lamp provided with a light-transmitting lamp vessel which is closed in a gastight manner and has a cavity in which an electric element is arranged, and which has a first and a second end portion in mutual opposition, each with a seal through which a respective first and second current conductor connected to the electric element is passed from the lamp vessel to the exterior, the second current conductor being guided through a duct in the reflector portion to the outer surface, while the electric lamp is fixed in the reflector body with the first end portion in the neck-shaped portion, the cavity within the reflector portion, and the electric element on the optical axis.

Such an electric lamp/reflector unit is known from WO1999032825. Units of this kind may be used for projection purposes, for example digital projection, film, or slide projection, but they may also be used in projection TV equipment. Users of such equipment continuously strive for cost price reduction so as to render this equipment cheaper, but without this resulting in this equipment becoming of lower quality, for example in that it has a lower lumen output. It is a disadvantage of the known lamp/reflector unit that the reflector body of high quality is relatively difficult to make via a relatively expensive manufacturing process.

It is an object of the invention to provide an electric lamp/reflector unit of the kind described in the opening paragraph in which the disadvantages of the known lamp/reflector unit are counteracted.

According to the invention, this object is achieved in that the electric lamp/reflector unit of the kind described in the opening paragraph is characterized in that said duct in the reflector portion is a punched duct essentially extending transversely to the reflector outer surface from the outer surface to the reflecting inner surface. The punched duct is about of the same size as the drilled duct of the conventional known molded reflector and makes the reflector of the unit according to the invention superior to the conventional known molded reflector body. Compared with the conventional known unit, the unit according to the invention has the advantages that:

the risk of chipped glass reflector parts or micro-cracks originating from the drilling process, which could eventually lead to cracked reflectors, is significantly reduced as the duct is formed while the glass of the reflector body can (still) be molded under external forces; this reduced risk of chipping improves the quality of the reflector;

dust particles (as formed in the conventional process due to the drilling step) are avoided, which makes for a simpler manufacturing process in which the drilling and washing steps are left out, which steps, however, are necessary in the process used for the conventional reflector bodies;

it is possible to provide the punched duct immediately after molding of the reflector body, i.e. when said reflector is still hot from its molding process step; in this way the making of the duct can be seen as an integral part of the molding process and hence does not require a separate process and additional handling and transport.

The lamp/reflector unit according to the invention can thus be readily manufactured at relatively low cost but without any loss of quality of the unit. The method is fit for reflectors made of various materials, for example made of soft-glass (e.g. soda-lime-glass), hard-glass (e.g. borosilicate glass), quartz glass, or glass-ceramic.

The molding process of the reflector body requires that the reflector body has such a shape that, once the reflector body has become sturdy, the reflector body and the mold can be mutually released, i.e. are self-releasable. The molded reflector body always has slightly widening parts in the direction from which the mold is withdrawn so as to release the reflector body, which in practice corresponds to a direction along the optical axis of the reflector. In both the conventional known reflector body and the reflector body of the invention, this slight widening is in the direction of the optical axis of the respective reflector body. The molded reflector body of the invention is provided with a duct which has the shape of an elongated bore obtained via hot deformation of glass and oriented in a direction significantly different from the direction of the optical axis, i.e. inclined with respect to the optical axis and practically transverse to the reflector outer surface. The presence of such a non-drilled, punched transverse duct in the reflector body is quite surprising as it results in a reflector body which is considered as not being self-releasable from the mold.

In an embodiment, the first current conductor is passed from the first end portion through the neck-shaped portion to the exterior, where it is connected to a further contact member on the outer surface of the reflector portion. The further contact member is not present in an axially shifted position behind the reflector portion, as in the known unit, but lies on the outer surface of the reflector portion. When the unit is projected along the optical axis onto a plane perpendicular to the optical axis, contours of the unit are imaged in said plane. The further contact member will lie within the contours of the reflector body in such a projection. The contact members on the outer surface accordingly do not lead to an enlargement of the unit in radial direction, while nevertheless a reduction in size of the unit in axial direction is realized. The use of this unit in projection equipment of smaller dimensions has become possible as a result. The equipment in which the unit is to be mounted comprises a terminal for the electrical connection of the unit to the equipment. In this embodiment of the unit according to the invention, the terminal does not lie axially behind the unit, but next to the unit, this in contrast to the known unit. The terminal will lie within the contours of the reflector body upon projection along the optical axis. A smaller axial dimension of the equipment can thus be realized without leading to an increase in the radial dimension of this equipment. The equipment may thus be smaller and lighter. The lumen output of the unit according to the invention has remained at least substantially the same as that of the known unit. The unit according to the invention offers the advantage of a higher lumen output over a unit in which the smaller dimension of the unit is achieved in that the reflector portion was reduced in axial direction. Furthermore, the two contact members can now lie at a comparatively large distance from one another, so that the risk of flashover between these members and/or current conductors is very small. It is thus possible to operate or (re)ignite a discharge arc at a high voltage comparatively safely. In this embodiment it is preferable that the contact members for the first and for the second current conductor are identical in shape. A smaller number of different operations are required as a result for achieving an electrical contact between the contact members and the current conductors. The operations are also less diverse, which simplifies the assembly of the unit. Moreover, a comparatively inexpensive assembling process can be achieved in the case of an automated manufacture on a large scale.

An embodiment the electric lamp/reflector unit is characterized in that the punched duct has a smallest surface in cross-section at or adjacent the reflecting inner surface of the reflector portion, preferably the punched duct at the reflecting inner surface is essentially circular in cross-section. The duct then has a relatively small opening at the reflecting surface, which makes the reflector body more efficient as the reduction in the reflecting surface area of the reflector is practically minimized.

In an alternative embodiment, the electric lamp/reflector unit is characterized in that the reflector portion is provided with a second punched duct. This renders it possible for the electric lamp/reflector unit to be provided with a starting aid, said starting aid being connected via a connection conductor that is passed through said second duct in the reflector portion. The risk of starting delays during (re)ignition of the lamp and hazardous situations arising therefrom is reduced by the starting aid.

In another favorable embodiment, the reflector body of the unit is manufactured from quartz glass or a glass-ceramic material which is resistant to thermal shocks. Glass-ceramic material has a comparatively low coefficient of thermal expansion, which is substantially zero in a temperature range from 20 to 500° C. Such a glass-ceramic material is obtained through partial crystallization of glass. The use of the reflector body manufactured from such a material improves the thermal shock resistance of the reflector body. It was also found that the reflector body has a higher temperature resistance and is better resistant to a possible explosion of the lamp. The use of the reflector body at a comparatively high temperature, for example up to approximately 700° C. instead of 450° C. as in the case of a glass reflector body, has thus become possible, and the safety of the unit has been improved.

The lamp vessel can be circumferentially secured to the reflector body in the neck-shaped portion, for example with an adhesive compound, for example with cement such as, for example, lamp cement. The adhesive compound for fastening the lamp in the neck-shaped portion, however, restricts ventilation in the space inside the reflector body. This is why the reflector body may have a profiled, for example ribbed outer surface. This increases the surface area of the outer surface, which makes for a better heat transfer.

The electric element may be an incandescent body, for example in an inert gas comprising halogen, or a pair of electrodes in an ionizable gas.

EP 595 412 discloses a lamp/reflector unit with a molded reflector body having a duct obtained by molding, which duct extends essentially along the optical axis. The opening of the duct into the reflecting surface is relatively large owing to the molding process and to the easy unmolding requirement, which makes the reflector body relatively inefficient due to the loss of the light that enters said opening.

Embodiments of the electric lamp/reflector unit according to the invention are diagrammatically shown in the drawing, in which:

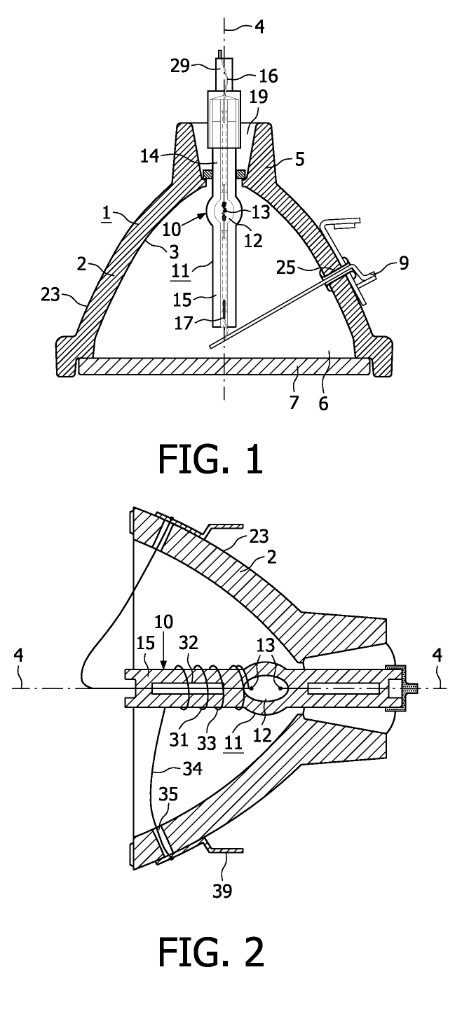

FIG. 1 shows a first embodiment in axial sectional view;

FIG. 2 shows a second embodiment in axial sectional view;

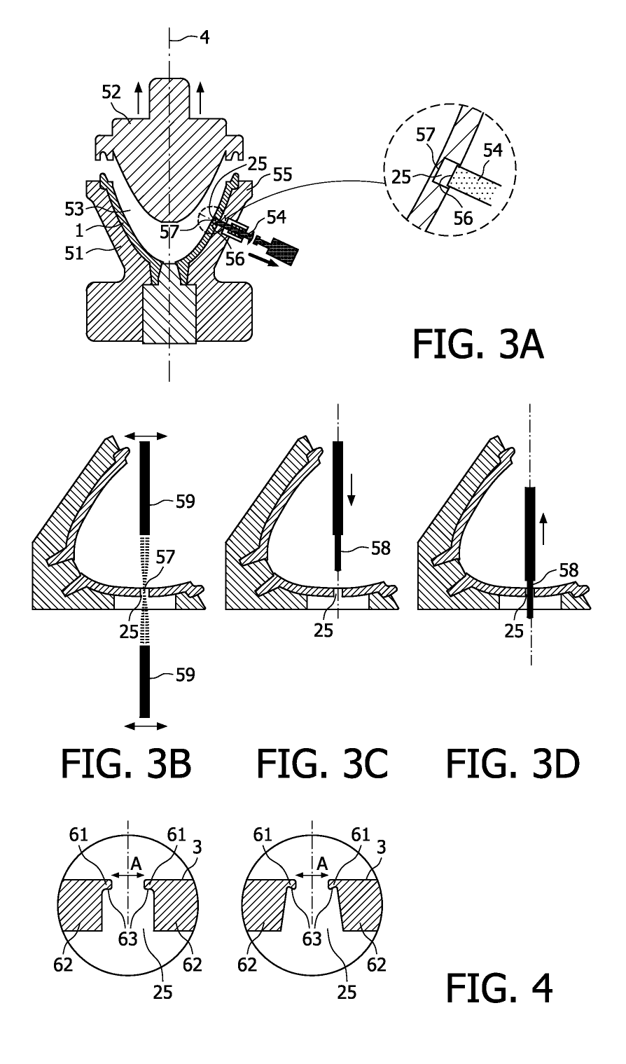

FIG. 3a-d shows various steps in a hot press/punch process; and

FIG. 4 shows details of some punched ducts in cross section.

In FIG. 1, the electric lamp/reflector unit has a molded reflector body 1 which is provided with a reflector portion 2 having an optical axis 4 and an outer surface 23, and integrally with the reflector portion 2 a hollow neck-shaped portion 5 surrounding the optical axis 4. The reflector portion 2 further comprises a concave, for example paraboloidally curved, reflecting inner surface 3 between the neck-shaped portion 5 and an originally open light emission window 6 which is transverse to the optical axis 4 and lidded by a transparent plate 7. In an alternative embodiment, however, said inner surface 3 may be, for example, ellipsoidally shaped. The reflector body 1 in the drawing is made of a glass-ceramic material and has a metal layer, for example an aluminum layer or a dichroic layer, serving as its reflecting inner surface 3. The body 1 may alternatively be made, for example, of glass, metal, or synthetic resin. The unit also comprises an electric lamp 10 which is provided with a light-transmitting lamp vessel 11 which is closed in a gastight manner and is made, for example, of quartz glass or alternatively of ceramic material, for example densely sintered aluminum oxide. Quartz glass is glass having a SiO₂ content of at least 95% by weight.

The lamp vessel 11 has a cavity 12 in which an electric element 13, an incandescent body in the Figure, is positioned. The lamp vessel 11 has a first 14 and a second, opposed end portion 15 with seal, through which a respective first 16 and second current conductor 17 is passed, said conductors being connected to the electric element 13 and issuing from the lamp vessel 11 to the exterior. The lamp 10 shown has an incandescent body 13 and a filling, for example a filling of rare gas such as, for example, xenon, for example at a pressure of several bar, for example 7 bar in the non-operational state, and one or several metal halides, possibly with mercury. The electric lamp 10, which dissipates approximately 35 W, is fixed in the reflector body 1, by means of cement 19 in the Figure, such that the first end portion 14 lies in the neck-shaped portion 5, the cavity 12 within the reflecting portion 2, and the electric element 13 on the optical axis 4.

The current conductor 17 issuing from the second end portion 15 is passed through a punched duct 25 in the reflector portion 2 to outside the lamp/reflector unit, where it is connected to a contact member 9 provided on the outer surface 23 of the reflector portion 2. The current conductor 16 is passed from the first end portion 14 through the neck-shaped portion 5 to the exterior, where it is connected to a further contact member 29.

In FIG. 2, parts corresponding to parts in FIG. 1 have been given the same reference numerals. The lamp 10 shown is a high-pressure mercury gas discharge lamp which has a pressure of approximately 180 bar or more during operation. A pair of electrodes 13 is positioned on the optical axis 4 in the cavity 12 of the lamp vessel 10, which contains mercury and a rare gas, for example argon, and bromine. The electric lamp 10 has a power rating of between approximately 50 and approximately 350 W. The electric lamp/reflector unit is provided with a starting aid 31. The starting aid 31 comprises a gas-filled cavity 32 in the second end portion 15 of the lamp 10. The cavity 32 comprises at least one gaseous ingredient of the filling, for example mercury vapor. The starting aid 31 further comprises an external antenna 33 adjacent the second end portion 15 at the area of the cavity 32. The antenna 33 is wound a few turns around the second end portion 15. The number of turns is at least one. The antenna 33 comprises a connection conductor 34 which is passed through a second punched duct 35 in the reflector portion 2 and is connected to a further contact member 39 provided on the outer surface 23.

FIG. 3a-d shows various steps in one of many possible hot press/punch processes. FIG. 3a shows a stage in a first step just after the reflector body 1 has been press-shaped through pressing of a quantity of hot glass between at least a first mold part 51 and a second mold part 52, i.e. in the press-space 53. Before the glass is provided in the press-space, a pin 54 is provided in the first mold part, the pin initially being in a position such that it projects through the wall 55 of the mold 51 into the press-space 53 where the hot glass is being shaped, thus shaping the punched duct 25 in the reflector body during the press-molding process. The pin 54 projects into the press-space 53 in a direction inclined with respect to, practically transverse to the direction from which the mold is withdrawn for releasing the reflector body, i.e. in practice this withdrawal takes place in a direction along the optical axis 4 of the reflector. Said pin 54 projects into said press-space so far that it just reaches the second mold part 52 during the stage in the press/punch process in which the first mold part 51 and second mold part 52 are in press-shaping position and the reflector body is being molded, allowing either only a very thin glass layer 57 to remain between a top 56 of the pin 54 and the second mold part 52 or squeezing the glass out of the region between said pin top 56 and the second mold part 52 altogether, which then make mutual physical contact. Once the reflector body 1 has been press-shaped and cooled down to such a low temperature that it has become sturdy, the pin 54 is withdrawn to no longer project into the press-space 53, thus enabling the first and second mold parts and the molded reflector body to be mutually released. FIG. 3b shows a first subsequent process step. This step may take place when the reflector body is still hot, i.e. immediately after its shaping punch/press process, and involves a local heating of the reflector body at the location of the punched duct 25 by burners 59. Said local heating either rounds off the edges of the duct at the reflecting surface (see FIG. 4 ref. nr. 61) somewhat or softens the very thin glass layer 57. As is shown in FIG. 3c-d, a shaping pin 58, having a circular cross-section in FIG. 3c-d, is inserted into the softened duct 25, causing the duct to take its final shape after the withdrawal of the burners. Two possible shapes of the duct are shown in FIG. 4 in cross-section through the reflector wall 62. Both ducts show a rim 63 at or adjacent the reflecting surface 3 of the reflector body. Said rim 63 gives the duct 25 a smallest circular surface A in cross-section at or adjacent the reflecting surface by which light losses are practically minimized. The process as described above enables the reflector to have a punched duct with a practically minimized distortion of the reflecting surface. An at least significantly lesser distortion is obtained than in a process in which a drilled duct is made or in which a punched duct is made through the reflector wall which is not pre-punched but still has its average original thickness. Depending on the shape of the shaping pin 58, the duct 25 may have a straight or a conical shape.

1. An electric lamp/reflector unit comprising:
a molded reflector body (1) provided with a reflector portion (2) having an optical axis (4), and with an outer surface (23) and integrally with said outer surface (23) a hollow neck-shaped portion (5) around the optical axis (4);
a concave reflecting inner surface (3) located between the neck-shaped portion (5) and a light emission window (6) transversely to the optical axis (4);
an electric lamp (10) provided with a light-transmitting lamp vessel (11) which is closed in a gastight manner and has a cavity (12) in which an electric element (13) is arranged, and which has a first (14) and a second end portion (15) in mutual opposition, each with a seal through which a respective first (16) and second current conductor (17) connected to the electric element (13) is passed from the lamp vessel (11) to the exterior, the second current conductor (17) being guided through a duct (25) in the reflector portion (2) to the outer surface (23), while the electric lamp (10) is fixed in the reflector body (1), with the first end portion (14) in the neck-shaped portion (5), the cavity (12) within the reflector portion (2), and the electric element (13) on the optical axis (4),
characterized in that said duct (25) in the reflector portion (2) is a punched duct essentially extending transversely to the reflector outer surface (23) from the outer surface (23) to the reflecting inner surface (3).

2. An electric lamp/reflector unit as claimed in claim 1, characterized in that the punched duct (25) has a smallest cross-section at or adjacent the reflecting inner surface (3) of the reflector portion (2).

3. An electric lamp/reflector unit as claimed in claim 1, characterized in that
the punched duct (25) at the reflecting inner surface (3) is essentially circular in cross-section.

4. An electric lamp/reflector unit as claimed in claim 1, characterized in that the reflector portion (2) is provided with a second punched duct (35).

5. An electric lamp/reflector unit as claimed in claim 1, characterized in that the electric lamp/reflector unit is provided with a starting aid (31).

6. An electric lamp/reflector unit as claimed in claim 4, characterized in that the starting aid (31) is connected to a connection conductor (34) which is passed through the second duct (35) in the reflector portion (2).

7. An electric lamp/reflector unit as claimed in claim 1, characterized in that the reflector body (1) is manufactured from quartz glass or a glass-ceramic material.
